(19) United States
(12) Patent Application Publication
(10) Pub. No.: US 2007/0200885 A1
(43) Pub. Date: Aug. 30, 2007

(54) INK-JET RECORDING APPARATUS

(75) Inventor: Manabu Hibi, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/679,305

(22) Filed: Feb. 27, 2007

(30) Foreign Application Priority Data
Feb. 27, 2006 (JP) 2006050303

(51) Int. Cl. B41J 29/38

(52) U.S. Cl. 347/11

(57) ABSTRACT

An ink-jet recording apparatus includes an ink-jet head having actuators and an actuator controller. The actuator controller supplies to the actuator an ejection pulse signal that appropriately switches the actuator between two states. When a time period Si (i=1, 2, . . . n), which is from a printing start point T0 to a point Ti (i=1, 2, . . . n) at which the ejection pulse signal is firstly supplied to actuators each corresponding to each of n nozzles (n denotes an arbitrary natural number) that are intended to eject ink based on print data, is longer than a predetermined time period Tw1, the actuator controller supplies the vibration pulse signal to each of the actuators within the time period Si.

### BACKGROUND OF THE INVENTION

1. Field of the Invention

The present invention relates to an ink-jet recording apparatus that performs printing by ejecting ink to a recording medium.

2. Description of Related Art

Japanese Patent Unexamined Publication No. 2005-14367 discloses an ink-jet type recording apparatus including a drive waveform generating means that selectively generates, as a drive waveform which will be outputted to an individual electrode, any one of a first drive waveform and a second drive waveform. The first drive waveform is for ejecting an ink droplet from a nozzle. The second drive waveform is not for ejecting an ink droplet from a nozzle but for vibrating a meniscus. In the ink-jet type recording apparatus, the number of inputs of an ejection timing signal is counted during a printing operation, and the second drive waveform is periodically outputted to an individual electrode corresponding to a nozzle that has not shown neither vibration of a meniscus nor ejection of an ink droplet for a predetermined period of time, in order to vibrate the meniscus. In addition, the second drive waveform is outputted immediately before a printing operation is started. This can prevent ink from thickening while a printing operation is being performed and immediately before a printing operation is started.

### SUMMARY OF THE INVENTION

In the ink-jet type recording apparatus disclosed in the above-mentioned document, however, it is uncertain whether an individual electrode to which the second drive waveform is outputted immediately before a printing operation is started is an individual electrode corresponding to a nozzle intended to eject ink in the current printing operation, an individual electrode corresponding to a nozzle not intended to eject ink in the current printing operation, or an individual electrode corresponding to every nozzle. Moreover, although the above-mentioned document states that a meniscus is vibrated immediately before a printing operation is started, it does not explicitly show at which timing a printing operation is started. Assuming that the second drive waveform is outputted to an individual electrode that corresponds to a nozzle intended to eject ink or to every nozzle and a timing of starting a printing operation is when a drive signal is inputted from a control means to a drive circuit, the prevention of ink thickening is spoiled and ink ejection from the nozzle becomes unstable if there is a longer time interval from when the printing operation is started to when the nozzle actually ejects an ink droplet.

An object of the present invention is to provide an ink-jet recording apparatus that allows ink to be ejected under a condition that thickening of ink in nozzles has been removed.

According to an aspect of the present invention, there is provided an ink-jet recording apparatus including an ink-jet head and an actuator controller. The ink-jet head performs printing while moving relative to a recording medium, and includes an ink ejection face having nozzles formed thereon, pressure chambers each communicating with each of the nozzles, and actuators adapted to take two states, that is, a first state where the actuator sets a volume of the pressure chamber at V1 and a second state where the actuator sets a volume of the pressure chamber at V2 which is larger than V1. The actuator controller supplies to the actuator an ejection pulse signal that appropriately switches the actuator between the two states to thereby make ink ejected from the nozzle, and a vibration pulse signal that appropriately switches the actuator between the two states to thereby, instead of making ink ejected from the nozzle, vibrates ink in the nozzle. When a time period Si (i=1, 2, . . . n), which is from a printing start point T0 at which at least a part of a recording medium starts to be opposed to the ink ejection face with respect to a direction of ink ejection from the nozzle to a point Ti (i=1, 2, . . . n) at which the ejection pulse signal is firstly supplied to actuators each corresponding to each of n nozzles (n denotes an arbitrary natural number) that are intended to eject ink based on print data, is longer than a predetermined time period Tw1, the actuator controller supplies the vibration pulse signal to each of the actuators within the time period Si.

In the aspect, when the vibration pulse signal is supplied to the actuator, ink in the nozzle is vibrated and stirred. Within the time period Si during which the part of the recording medium is opposed to the ink ejection face, the vibration pulse signal is supplied to the actuator. The ejection pulse signal is supplied within a relatively short period after the vibration pulse signal is supplied to the actuator. Accordingly, ink ejection from the nozzle can be performed under a condition that thickening of ink in the nozzle has been removed. As a result, ink ejection is stabilized.

### BRIEF DESCRIPTION OF THE DRAWINGS

Other and further objects, features and advantages of the invention will appear more fully from the following description taken in connection with the accompanying drawings in which:

FIG. 1 schematically illustrates a construction of an ink-jet printer according to an embodiment of the present invention;

FIG. 2 is a plan view of a head main body that is included in the ink-jet printer shown in FIG. 1;

FIG. 3 shows on an enlarged scale a part enclosed by an alternate long and short dash line in FIG. 2;

FIG. 4 is a sectional view as taken along line IV-IV in FIG. 3;

FIG. 5 is a plan view on an enlarged scale of a part of an actuator unit shown in FIG. 2;

FIG. 6 is a block diagram schematically showing an electrical construction of the ink-jet printer shown in FIG. 1;

FIG. 7 is a waveform diagram showing ejection waveform signals that are generated by respective parts of an ejection waveform generator illustrated in FIG. 6;

FIG. 8 is a waveform diagram showing a fundamental waveform of a preliminary vibration waveform signal that is generated by a preliminary vibration waveform generator shown in FIG. 6;

FIGS. 9A and 9B are schematic diagrams showing print signals that are supplied by a print signal supplier shown in FIG. 6, with the ejection waveform signal and the preliminary vibration waveform signal being applied thereto, respectively;

FIG. 10 shows a state where for every sub manifold channel a delay occurs in a rectangular wave of the ejection waveform signal; and

FIGS. 11A, 11B, and 11C are timewise views showing ink being ejected from a nozzle by driving of the actuator unit.

### DESCRIPTION OF THE PREFERRED EMBODIMENTS

In the following, a certain preferred embodiment of the present invention will be described with reference to the accompanying drawings.

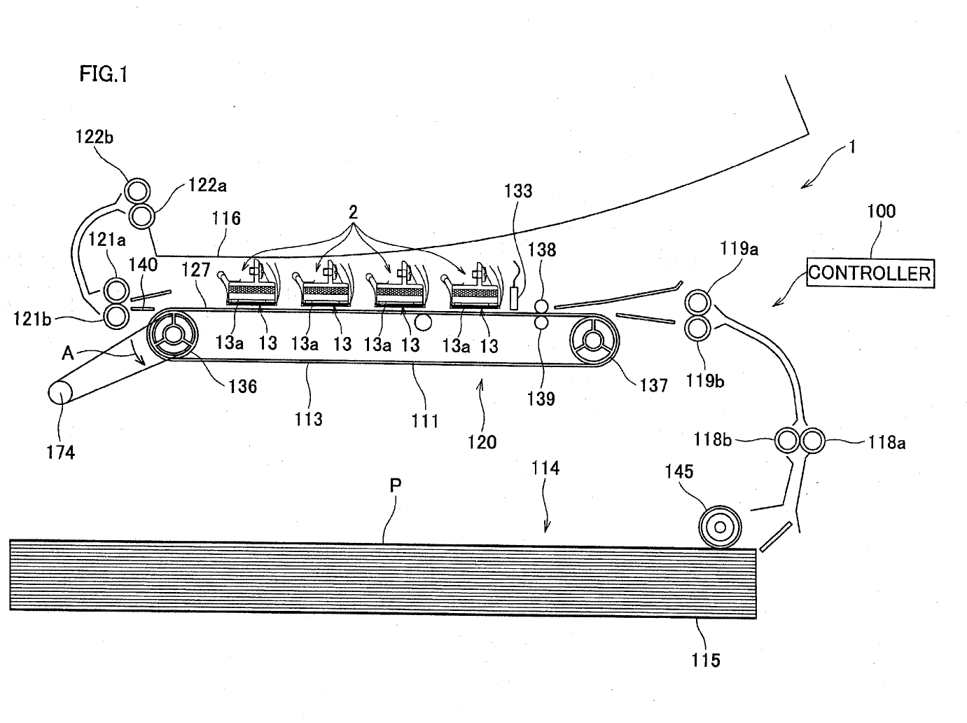

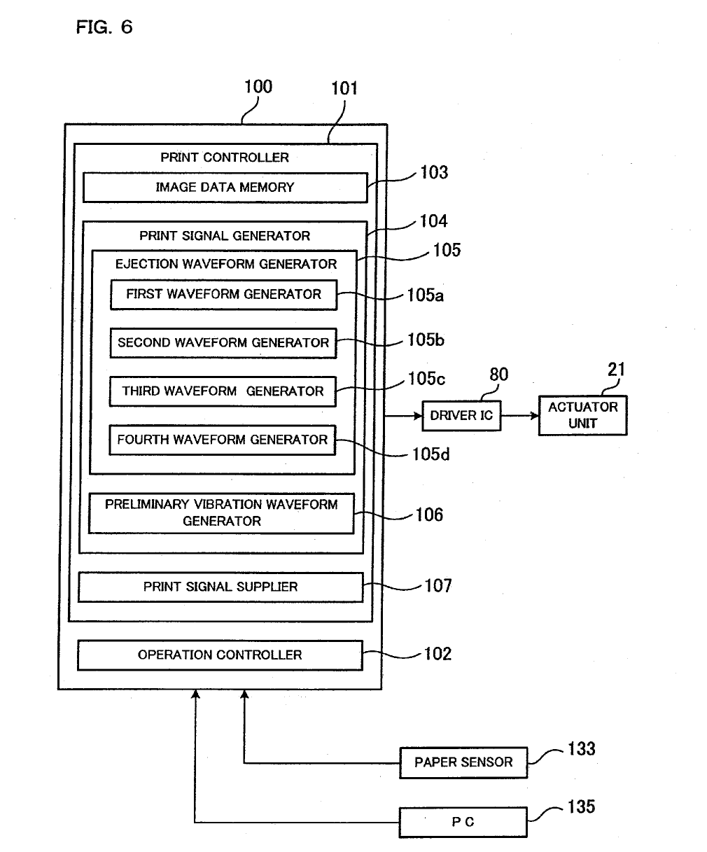

FIG. 1 schematically illustrates a construction of an ink-jet printer 1 according to an embodiment of the present invention. The printer 1 is a color ink-jet printer of line type having four fixed ink-jet heads 2. Each of the ink-jet heads 2 is elongated in a direction perpendicularly crossing the drawing sheet of FIG. 1. The printer 1 includes a paper feed unit 114, a paper receiving tray 116, and a conveyance unit 120, which are shown in lower, upper, and middle parts of FIG. 1, respectively. The printer 1 also includes a controller 100 that controls operations of the paper feed unit 114, the paper receiving tray 116, and the conveyance unit 120. The controller 100 controls driving of the ink-jet heads 2 through a driver IC 80 (see FIG. 6).

The paper feed unit 114 has a paper holder 115 and a paper feed roller 145. A stack of rectangular papers P are held in the paper holder 115. The paper feed roller 145 sends out to the conveyance unit 120 an uppermost one of the papers P held in the paper holder 115 one by one. The paper holder 115 holds a paper P in such a manner that the paper P is send out in a direction parallel to its longer side. Between the paper feed unit 114 and the conveyance unit 120, two pairs of feed rollers 118a and 118b, and 119a and 119b are disposed along a conveyance path for the paper P. A paper P sent out from the paper feed unit 114 is, while being led by one shorter side thereof, sent upward in FIG. 1 by the feed rollers 118a and 118b. Then, by the feed rollers 119a and 119b, the paper P is sent toward the conveyance unit 120.

The conveyance unit 120 has an endless conveyor belt 111, and two belt rollers 136 and 137 on which the conveyor belt 111 is wound. A length of the conveyor belt 111 is adjusted such that a predetermined tension occurs in the conveyor belt 111. The conveyor belt 111, which is wound on the two belt rollers 136 and 137, defines two parallel planes each including a tangent line that is common to the belt rollers 136 and 137. Of these two planes, the one opposed to the ink-jet heads 2 forms a conveyor face 127 for the paper P. A paper P sent out of the paper feed unit 114 is conveyed on the conveyor face 127, and in this condition the ink-jet heads 2 perform printing on an upper face of the printing paper P. Then, the paper P reaches the paper receiving tray 116. Papers P thus printed are piled in the paper receiving tray 116.

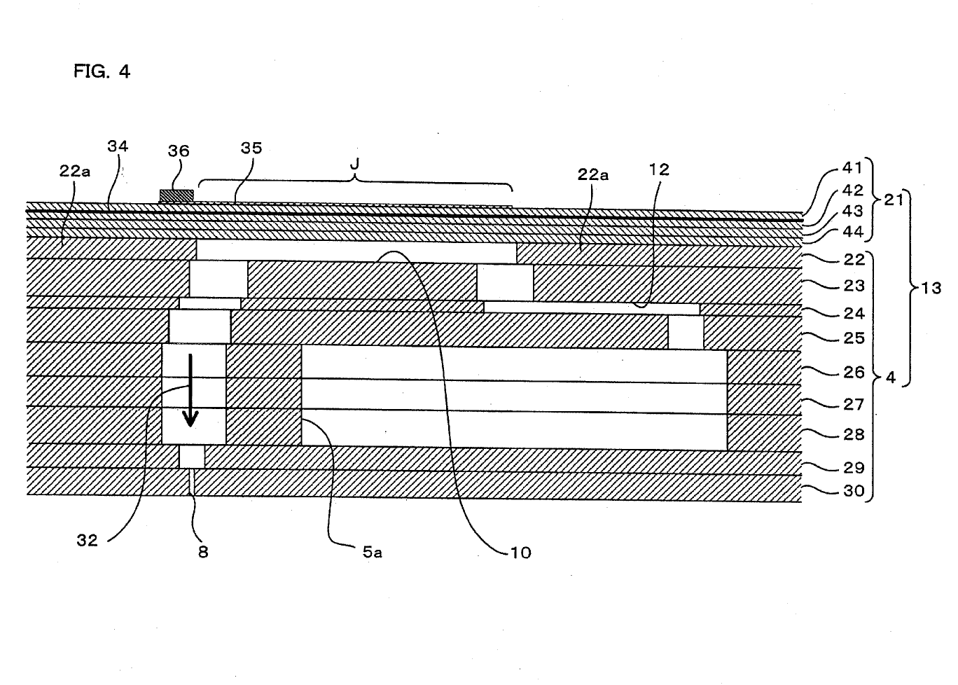

The four ink-jet heads 2 are disposed adjacent to each other along the conveyance path for the paper P, that is, along a horizontal direction in FIG. 1. Each of the ink-jet heads 2 has a head main body 13 at its lower end. The head main body 13 includes a passage unit 4 having many individual ink passages 32 formed therein (see FIG. 4), and four actuator units 21 bonded to an upper face of the passage unit 4 with an adhesive. Each of the individual ink passages 32 has one nozzle 8 and one pressure chamber 10 that communicates with the one nozzle 8. The actuator unit 21 applies pressure to ink contained in a desired pressure chamber 10. An unillustrated Flexible Printed Circuit (FPC) is bonded to each actuator unit 21, and supplies to the actuator unit 21 an ejection pulse signal and a vibration pulse signal which will be described later.

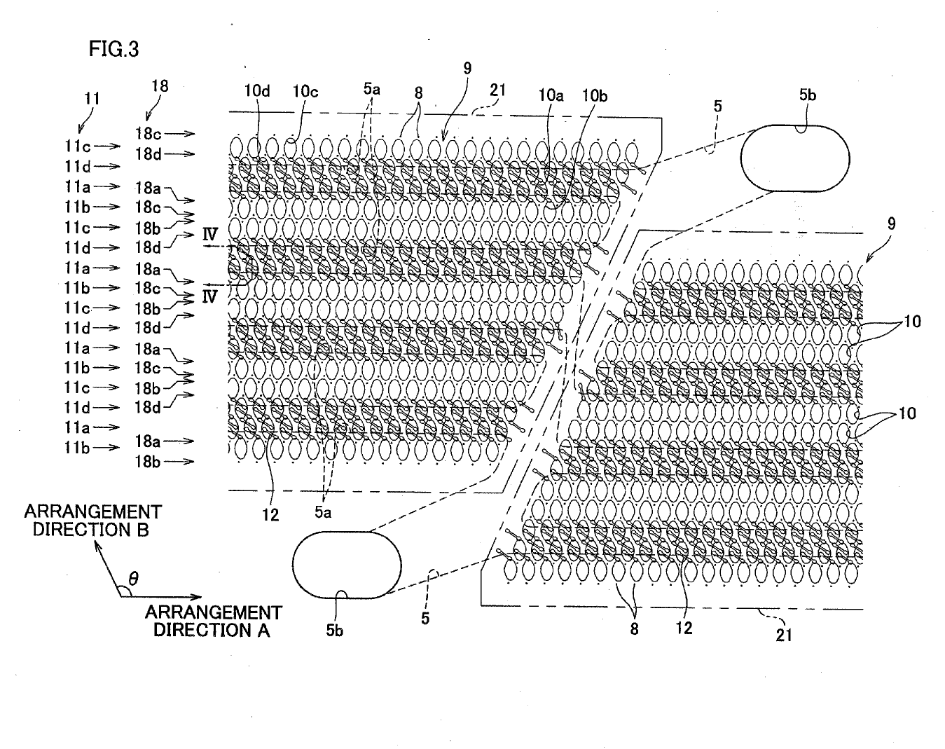

Many small-diameter nozzles 8 are formed on a bottom face of each head main body 13, that is, on an ink ejection face 13a (see FIGS. 3 and 4). A color of ink ejected from a nozzle 8 is any of magenta, yellow, cyan, and black. The four head main bodies 13 eject ink of four different colors of magenta, yellow, cyan, and black, respectively.

A narrow space is formed between the ink ejection face 13a and the conveyor face 127 of the conveyor belt 111. A conveyance path is formed through the space, and a paper P is conveyed along the conveyance path from right to left in FIG. 1. While the paper P sequentially goes through the clearance, ink is ejected from the nozzles 8 toward an upper face of the paper P, so that a colored image based on image data is formed on the paper P.

The belt roller 136 is connected to a conveyor motor 174. When the conveyor motor 174 is driven under control of the controller 100, driving force is transmitted to the belt roller 136 which thereby rotates in an arrow A direction. Thus, the conveyor belt 111 travels, so that a paper P placed on the conveyor belt 111 is conveyed. The belt roller 137 is a slave roller that is rotated by rotational force given from the conveyor belt 111 along with rotation of the belt roller 136.

A nip roller 138 and a nip bearing roller 139 are disposed near the belt roller 137, so as to sandwich the conveyor belt 111 therebetween. The nip roller 138 is biased downward by an unillustrated spring, in order to press, to the conveyor face 127, the paper P supplied to the conveyance unit 120. The paper P as well as the conveyor belt 111 is nipped between the nip roller 138 and the nip bearing roller 139. Since an outer surface 113 of the conveyor belt 111 is treated with adherent silicone rubber, the paper P securely adheres to the conveyor face 127.

As shown in FIG. 1, a peeling plate 140 is provided on a left side of the conveyance unit 120. A right end of the peeling plate 140 goes into between the paper P and the conveyor belt 111, thereby peeling the paper P from the conveyor face 127.

Two pairs of feed rollers 121a and 121b, and 122a and 122b are disposed between the conveyance unit 120 and the paper receiving tray 116. The paper P peeled by the peeling plate 140 is sent upward in FIG. 1 by the feed rollers 121a and 121b. Then, the paper P is sent to the paper receiving tray 116 by the feed rollers 122a and 122b.

A paper sensor 133 is disposed between the nip roller 138 and the most upstream one of the ink-jet heads 2. The paper sensor 133 is an optical sensor including a light emitter and a light receiver, and detects a leading edge of the paper P on the conveyance path. A detection signal outputted from the paper sensor 133 is sent to the controller 100, and used for forming an image in synchronization with conveyance of the paper P.

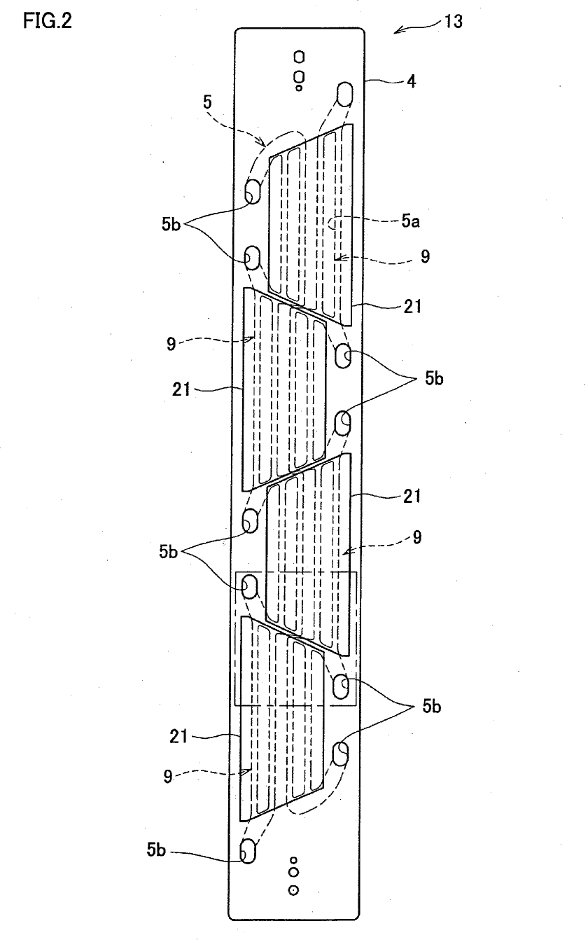

Next, details of the head main body 13 will be described. FIG. 2 is a plan view of the head main body 13 illustrated in FIG. 1. FIG. 3 shows on an enlarged scale a part enclosed with an alternate long and short dash line in FIG. 2. As shown in FIG. 2, the actuator units 21 each having a trapezoidal shape are arranged in two rows and in a zigzag pattern on the upper face of the passage unit 4. To be more specific, each of the actuator units 21 is disposed with its parallel opposed sides, which mean upper and lower sides, extending along a longitudinal direction of the passage unit 4. Oblique sides of every neighboring actuator units 21 partially overlap each other with respect to a widthwise direction of the passage unit 4.

On the upper face of the passage unit 4, a pressure chamber group 9 made up of many pressure chambers 10 is provided in a region where each actuator unit 21 is bonded. On a lower face of the passage unit 4 or the ink ejection face 13a, many nozzles 8 are arranged in a matrix in a region corresponding to the above-mentioned region where each actuator unit 21 is bonded. Each of the nozzles 8 communicates with a corresponding pressure chamber 10. Thus, a region of the ink ejection face 13a opposed to the actuator unit 21 serves as an ink ejection region in which the many nozzles 8 are formed.

Formed within the passage unit 4 are manifold channels 5 and sub manifold channels 5a which are branch passages of the manifold channels 5. The manifold channel 5 extends along the oblique side of the actuator unit 21 and branches into several sub manifold channels 5b. The sub manifold channels 5a are branched from both sides of each manifold channel 5. One ink ejection region is opposed to four sub manifold channels 5a that extend in the longitudinal direction of the passage unit 4. On the upper face of the passage unit 4, openings 5b are provided so as to keep away from the actuator units 21. The openings 5b communicate with the manifold channels 5. Ink is supplied from an unillustrated ink tank through the openings 5b to the manifold channels 5 and the sub manifold channels 5a.

As shown in FIG. 3, pressure chambers 10 constituting the pressure chamber group 9 are arranged neighboring each other in a matrix in two directions, that is, in an arrangement direction A and an arrangement direction B. The arrangement direction A is the longitudinal direction of the passage unit 4, and is in parallel to a shorter diagonal of the pressure chamber 10 which has a substantially rhombic shape. The arrangement direction B is in parallel to one oblique side of the pressure chamber 10, and forms an obtuse angle e with the arrangement direction A. In the pressure chamber group 9, a pressure chamber 10 has its acute portion located between two pressure chambers 10 neighboring thereto. With respect to the arrangement direction A, the pressure chambers 10 are spaced apart from each other at intervals corresponding to 37.5 dpi, while with respect to the arrangement direction B sixteen pressure chambers 10 are arranged. The pressure chambers 10 are regularly arranged at fixed intervals along the arrangement direction A to thereby form pressure chamber rows 11, and sixteen pressure chamber rows 11 are arranged in parallel to each other to thereby form each pressure chamber group 9. As a result of the pressure chambers 10 being arranged in this way, an image can be formed at a resolution of 600 dpi as a whole. The pressure chamber rows 11 are, depending on their position relative to the sub manifold channels 5a as seen in the direction perpendicularly crossing the drawing sheet of FIG. 3, classified into first pressure chamber rows 11a, second pressure chamber rows 11b, third pressure chamber rows 11c, and fourth pressure chamber rows 11d. The first to fourth pressure chamber rows 11a to 11d are arranged periodically in an order of 11c, 11d, 11a, 11b, 11c, 11d, . . . 11b from the upper side to the lower side of the actuator unit 21.

When seen in the direction perpendicularly crossing the drawing sheet of FIG. 3, nozzles 8 communicating with pressure chambers 10a included in the first pressure chamber rows 11a and nozzles 8 communicating with pressure chambers 10b included in the second pressure chamber rows 11b are concentrated at a lower side in FIG. 3 with respect to the direction perpendicular to the arrangement direction A. Each of the nozzles 8 locates near a lower end of its corresponding pressure chamber 10. Nozzles 8 communicating with pressure chambers 10c included in the third pressure chamber rows 11c and nozzles 8 communicating with pressure chambers 10d included in the fourth pressure chamber rows 11d are concentrated at an upper side in FIG. 3 with respect to the direction perpendicular to the arrangement direction A. Each of the nozzles 8 locates near an upper end of its corresponding pressure chamber 10. When seen in the direction perpendicularly crossing the drawing sheet of FIG. 3, each of the pressure chambers 10a and 10d included in the first and fourth pressure chamber rows 11a and 11d has half or more of its area overlapping the sub manifold channel 5a. When seen in the direction perpendicularly crossing the drawing sheet of FIG. 3, each of the pressure chambers 10b and 10c included in the second and third pressure chamber rows 11b and 11c has a substantially entire area thereof not overlapping the sub manifold channel 5a. That is, the sub manifold channel 5a is provided making good use of a width between neighboring two pressure chamber rows 11a and 11d. In this way, a width of a sub manifold channel 5a can be enlarged as wide as possible in order to smoothly supply ink to respective pressure chambers 10a to 10d, while preventing the sub manifold channel 5a from overlapping nozzles 8 that communicate with any of the pressure chambers 10a to 10d.

In each ink ejection region, the nozzles 8 form sixteen nozzle rows 18 extending in the longitudinal direction of the passage unit 4. The nozzle rows 18 are disposed corresponding to the respective pressure chamber rows 11. The nozzle rows 18 are, depending on their positional relationships with the sub manifold channels 5a, classified into first nozzle rows 18a, second nozzle rows 18b, third nozzle rows 18c, and fourth nozzle rows 18d. The first to fourth nozzle rows 18a to 18d are arranged in an order of 18c, 18d, 18a, 18c, 18b, 18d, . . . 18b, 18d, 18a, 18b from the upper side to the lower side of the actuator unit 21. In the middle of the arrangement, a sequence of the nozzle rows 18b and 18c corresponding to the pressure chamber rows 11b and 11c is inverse to a sequence of the pressure chamber rows 11b and 11c. This is because an acute portion of each pressure chamber 10 is sandwiched between other pressure chambers 10 neighboring thereto, as described above. In a plan view, the third and fourth nozzle rows 18c and 18d are placed on an upper side of the sub manifold channel 5a, and the first and second nozzle rows 18a and 18b are placed on a lower side of the sub manifold channel 5a. One sub manifold channel 5a that are sandwiched among the nozzle rows 18c, 18d, 18a, and 18b are shared by these nozzle rows 18c, 18d, 18a, and 18b. Each of the nozzles 8 included in these nozzle rows 18a to 18d communicates with the one sub manifold channel 5a through a pressure chamber 10 and an aperture 12 acting as a throttle (see FIG. 4). In FIG. 3, in order to facilitate understanding of the drawing, the actuator units 21 are illustrated with alternate long and two short dashes lines, while pressure chambers 10, apertures 12, and nozzles 8 are illustrated with solid lines though they should actually be illustrated with broken lines because they locate under the actuator units 21.

The nozzles 8 are formed in such positions that, when they are projected in a direction perpendicular to an imaginary line that extends in the longitudinal direction of the passage unit 4, their projective points onto the imaginary line are arranged at regular intervals at 600 dpi.

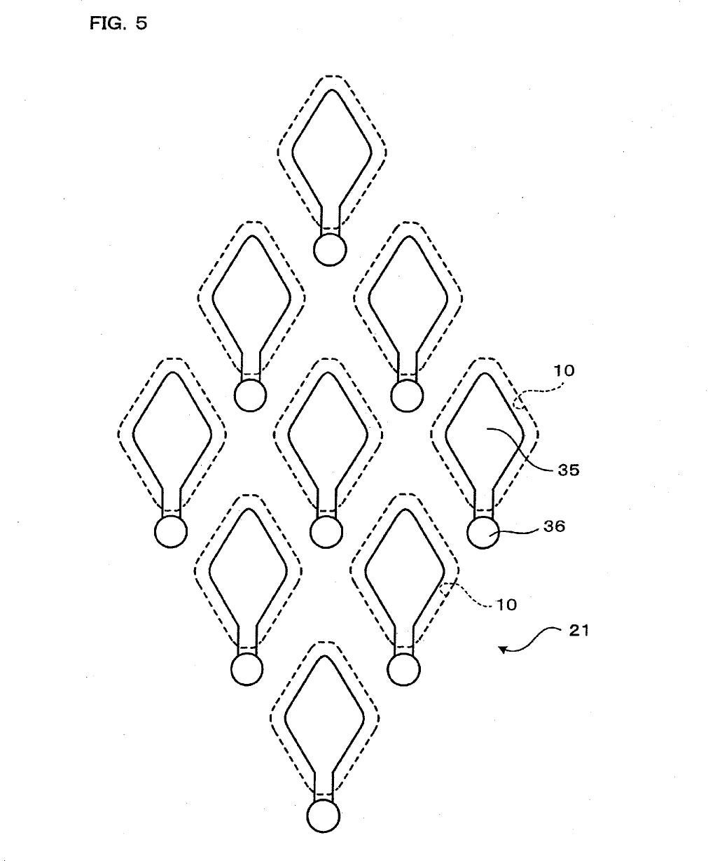

Next, a cross section structure of the head main body 13 will be described. FIG. 4 is a sectional view as taken along line IV-IV in FIG. 3. FIG. 5 is a plan view on an enlarged scale of a part of the actuator unit 21. As shown in FIG. 4, the passage unit 4 has a layered structure of, from the top, a cavity plate 22, a base plate 23, an aperture plate 24, a supply plate 25, manifold plates 26, 27, 28, a cover plate 29, and a nozzle plate 30. Any of the plates 22 to 30 is made of a metal.

Formed within the passage unit 4 are ink passages that extend to the nozzles 8 at which ink supplied from outside is ejected. The ink passages include the manifold channels 5 and the sub manifold channels 5a in which ink is temporarily stored, and also include many individual ink passages 32 each extending from an outlet of a sub manifold channel 5a to a nozzle 8. Recesses or holes that constitute the ink passages are formed in the respective plates 22 to 30.

Formed in the cavity plate 22 are many substantially rhombic holes serving as pressure chambers 10. Formed in the base plate 23 are connection holes each connecting each pressure chamber 10 to a corresponding aperture 12 and connection holes each connecting each pressure chamber 10 to a corresponding nozzle 8. Formed in the aperture plate 24 are holes serving as apertures 12 and connection holes each connecting each pressure chamber 10 to a corresponding nozzle 8. Formed in the supply plate 25 are connection holes each connecting each aperture 12 to a sub manifold channel 5a and connection holes each connecting each pressure chamber 10 to a corresponding nozzle 8. Formed in each of the manifold plates 26, 27, and 28 are holes constituting sub-manifold channels 5a and connection holes each connecting each pressure chamber 10 to a corresponding nozzle 8. Formed in the cover plate 29 are connection holes each connecting each pressure chamber 10 to a corresponding nozzle 8. Formed in the nozzle plate 30 are many holes serving as nozzles 8. The nine metal plates are positioned in layers so as to form individual ink passages 32.

As shown in FIG. 4, the actuator unit 21 has four piezoelectric sheets 41, 42, 43 and 44 laminated to each other. Each of the piezoelectric sheets 41 to 44 has the same thickness of approximately 15 μm, and thus the actuator unit 21 has a thickness of approximately 60 μm. Any of the piezoelectric sheets 41 to 44 extends over many pressure chambers 10 that constitute one pressure chamber group 9. The piezoelectric sheets 41 to 44 are made of a lead zirconate titanate (PZT)-base ceramic material having ferroelectricity.

An individual electrode 35 having a thickness of approximately 1 μm is formed on the uppermost piezoelectric sheet 41. As shown in FIG. 5, the individual electrode 35 has a substantially rhombic shape in a plan view. The individual electrode 35 is formed in such a manner that it is opposed to a pressure chamber 10 and at the same time its large part falls within the pressure chamber 10 in a plan view. Consequently, on a substantially whole area of the uppermost piezoelectric sheet 41, many individual electrodes 35 are arranged in a matrix in two dimensions. A common electrode 34 having a thickness of approximately 2 μm is interposed between the uppermost piezoelectric sheet 41 and the piezoelectric sheet 42 disposed under the uppermost piezoelectric layer 41. The common electrode 34 is formed over an entire face of the sheet. Both of the individual electrode 35 and the common electrode 34 are made of a metal material such as an Ag—Pd-base one. As shown in FIG. 4, a portion of the actuator unit 21 where the individual electrode 35 is placed is a pressure generator J or an actuator, which applies pressure to ink contained in the pressure chamber 10. That is, the actuator unit 21 is provided therein with actuators independently for the respective pressure chambers 10. The actuator unit 21 is of so-called unimorph type, in which only the uppermost piezoelectric sheet 41 includes an active portion that is distorted by an external electric field while the other piezoelectric sheets 42 to 44 are inactive layers.

As shown in FIG. 5, one acute portion of the individual electrode 35 extends out to outside of the pressure chamber 10, and a land 36 is provided on a vicinity of an end of this extending-out portion. The land 36 is located above a partition wall 22a of the cavity plate 22 (see FIG. 4). The partition wall 22a is a portion of the cavity plate 22 where no pressure chamber 10 is formed, and bonded to the actuator unit 21. That is, the land 36 is formed at a position not overlapping the pressure chamber 10 with respect to a thickness direction of the actuator unit 21. The land 36 is electrically connected to a contact of an unillustrated FPC. The land 36 has a round shape, with a thickness of approximately 15 μm and a diameter of approximately 160 μm. The land 36 is made for example of gold including glass frits.

The common electrode 34 is grounded in an unillustrated region thereof, and equally maintained at the ground potential in its portions opposed to all the pressure chambers 10. In order that potentials of respective individual electrodes 35 can be controlled independently, an unillustrated FPC through which the individual electrodes 35 are electrically connected to a driver IC 80 (see FIG. 6) includes wires that are provided for the respective individual electrodes 35 independently of one another. On the piezoelectric sheet 41, a surface electrode is formed so as to keep away from a group of the individual electrodes 35. The surface electrode is electrically connected to the common electrode 34 via a through hole, and connected to a wire of the FPC different from the wires provided for the individual electrodes 35.

Next, a driving mode of the actuator unit 21 will be described. The piezoelectric sheet 41 of the actuator unit 21 is polarized in its thickness direction. As described above, the actuator unit 21 is of so-called unimorph type, in which the upper piezoelectric sheet 41 distant from the pressure chamber 10 is a layer including the active portion while the lower three piezoelectric sheets 42 to 44 close to the pressure chamber 10 are inactive layers. Therefore, when the individual electrode 35 is set at a positive potential which makes an electric field and polarization occur in the same direction, a portion of the piezoelectric sheet 41 sandwiched between the electrodes 34 and 35 works as an active portion and contracts perpendicularly to the polarization direction due to a transversal piezoelectric effect. The other piezoelectric sheets 42 to 44 are not affected by the electric field, and therefore do not contract by themselves. Thus, the piezoelectric sheet 41 and the lower piezoelectric sheets 42 to 44 present difference in distortion in a direction perpendicular to the polarization direction. As a result, the piezoelectric sheets 41 to 44 are as a whole going to deform protrudingly downward (unimorph deformation). Here, a lower face of the piezoelectric sheets 41 to 44 is fixed onto the partition wall 22a of the cavity plate 22 as shown in FIG. 4. Therefore, a portion of the piezoelectric sheets 41 to 44 corresponding to the active portion deforms protrudingly toward the pressure chamber 10. This reduces the volume of the pressure chamber 10 thus raising pressure of ink contained in the pressure chamber 10. When the individual electrode 35 is set at a negative potential which makes an electric field and polarization occur in opposite directions, a portion of the piezoelectric sheets 41 to 44 corresponding to the active portion deforms protrudingly upward, so that pressure of ink contained in the pressure chamber 10 drops.

An individual electrode 35 is in advance set at a positive potential. Upon every ejection request, the individual electrode 35 is once set at a negative potential and then at a predetermined timing is set at the positive potential again. In this case, in an initial state where the individual electrode 35 is at the positive potential, a portion of the piezoelectric sheets 41 to 44 corresponding to an active portion has deformed protrudingly toward a pressure chamber 10 Then, at a timing of setting the individual electrode 35 at the negative potential, the piezoelectric sheets 41 to 44 are formed into a flat shape, so that the volume of the pressure chamber 10 becomes larger than in the initial state. Consequently, pressure of ink contained in the pressure chamber 10 drops, to suck ink from the sub manifold channel 5b into an individual ink passage 32. Then, at a timing of setting the individual electrode 35 at the positive potential again, the portion of the piezoelectric sheets 41 to 44 corresponding to the active portion deforms protrudingly toward the pressure chamber 10. This reduces the volume of the pressure chamber 10 thus raising pressure of ink contained in the pressure chamber 10, so that ink is ejected from a nozzle 8. Such an ejection method is generally called as “fill before fire”. In order that ink is ejected from a nozzle 8, there must be a predetermined potential difference between the positive potential and the negative potential.

An ejection pulse signal is supplied to the individual electrode 35. The ejection pulse signal has a group of rectangular waves. When a width of the rectangular wave included in the ejection pulse signal is equal to a time length AL (Acoustic Length) which is required for a pressure wave to propagate through ink from an outlet of a sub manifold channel 5a to a nozzle 8, ink is ejected under high pressure or at a high speed. In this embodiment, a pressure generator J is located at a middle portion of an individual ink passage 32, and a period of time from when an individual electrode 35 is set at the negative potential to when the individual electrode 35 is set at the positive potential, which means a width of a rectangular wave, is close to a period of time required for a negative pressure wave generated in a pressure chamber 10 to return to the pressure chamber 10 by being reflectively inverted to positive in the vicinity of a sub manifold channel 5a, which means an AL.

A gradation is expressed by means of a volume of ink which is controlled by the number of ink droplets ejected from a nozzle 8. One ink droplet or several ink droplets sequentially ejected form(s) one dot on a paper. When a sequence of ink droplets is ejected, an interval between pulses each supplied for ejecting an ink droplet is set at the AL. This allows a peak of a residual wave of pressure applied for ejecting an earlier ink droplet to coincide with a peak of a wave of pressure applied for ejecting a next ink droplet. Consequently, the two pressure waves are superimposed and thus amplified, so that the next ink droplet is ejected at a higher speed than the earlier ink droplet is. As a result, the next ink droplet catches up with and collide with the earlier ink droplet, so that it is united with the earlier ink droplet.

Here, control of the actuator unit 21 will be described with reference to FIG. 6. A controller 100 includes an unillustrated CPU (Central Processing Unit), an unillustrated ROM (Read Only Memory), and an unillustrated RAM (Random Access Memory). The CPU is an arithmetic processing unit. The ROM stores therein a program executed by the CPU and data used for the program. The RAM temporarily stores data therein during execution of the program. Parts which will be described below are constructed of these units.

The controller 100 has a print controller 101 and an operation controller 102. Based on image data and operation data concerning a printing operation which are transmitted from a paper sensor 133 and a PC (Personal Computer) 135, the operation controller 102 controls driving of a motor that drives the paper feed roller 145, a motor that drives the feed rollers 118a, 118b, 119a, 119b, 121a, 121b, 122a, and 122b, a conveyor motor 174, and the like. Since the paper sensor 133 is spaced apart from the most upstream one of the ink-jet heads 2, a paper P is not yet opposed to the ink-jet heads 2 at a time point when the paper sensor 133 detects a leading edge of the paper P. A positional relationship between the paper sensor 133 and the ink-jet head 2 is fixed, that is, they are spaced apart at a fixed distance. Accordingly, based on a detection signal that is outputted from the paper sensor 133 to the controller 100 upon detection of the leading edge of the paper P, the print controller 101 performs control in consideration of a distance between the paper sensor 133 and the most upstream ink-jet head 2, so as to make a printing operation start at a time point when the paper P starts to be opposed to the most upstream ink-jet head 2. That is, the print controller 101 performs control in such a manner that printing on the paper P is started at a time when the paper P whose conveyance is controlled by the operation controller 102 starts to be opposed to the most upstream ink-jet head 2.

The print controller 101 includes an image data memory 103, a print signal generator 104, and a print signal supplier 107. The image data memory 103 stores therein image data concerning a printing operation which is transmitted from the PC 135. The print signal generator 104 has an ejection waveform generator 105 and a preliminary vibration waveform generator 106.

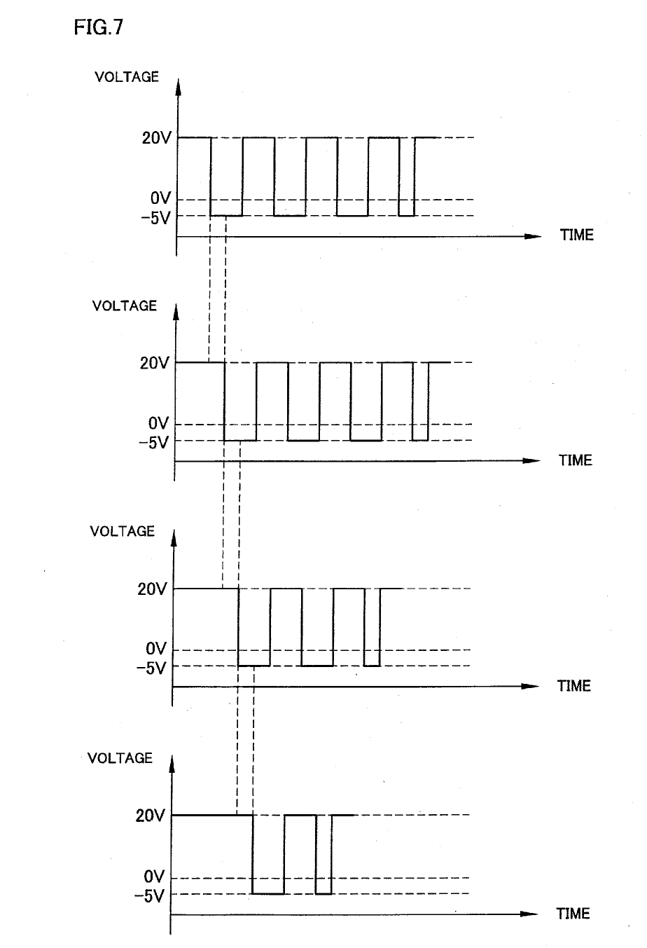

The ejection waveform generator 105 includes a first waveform generator 105a, a second waveform generator 105b, a third waveform generator 105c, and a fourth waveform generator 105d. The first to fourth waveform generators 105a to 105d can generate ejection waveform signals that represent different gradations, respectively. The first to fourth waveform generators 105a to 105d correspond respectively to the first to fourth pressure chamber rows 11a to 11d that are connected to the first to fourth nozzle rows 18a to 18d. The first to fourth waveform generators 105a to 105d generate ejection waveform signals and supply them to respective actuators. One actuator has one individual electrode 35. Detailed description about this will be given later. Each of four graphs in FIG. 7 shows an example of the ejection waveform signal generated by each of the four waveform generators 105a to 105d. As will be described later, respective ejection waveform signals generated by the first to fourth waveform generators 105a to 105d are delayed by a delay circuit included in the print signal supplier 107, with a delay time being different for every one of the four sub manifold channels 5a, so that these ejection waveform signals are made into four out-of-phase signals.

As shown in FIG. 7, each of the ejection waveform signals is a group of rectangular concave waves. The ejection waveform signal is determined by the number of ink droplets, and a phase and a cycle of a waveform pattern. The number of ink droplets is calculated out from four levels of ink ejection amounts, including no ejection, determined based on gradation data that is included in image data. More specifically, in the waveform pattern, rectangular waves each having a width of an AL (approximately 7 μsec) determined by a falling timing and a rising timing come in series at AL intervals, and finally a rectangular wave whose width is half the AL is added. The number of the rectangular waves corresponds to the number of ink droplets to be ejected (1 to 3). The final rectangular wave cancels residual pressure in a pressure chamber 10.

The first to fourth waveform generators 105a to 105d generate ejection waveform signals that are out of phase with each other, as shown in FIG. 7. To be more specific, an ejection waveform signal generated by the second waveform generator 105b is phase-delayed from an ejection waveform signal generated by the first ejection waveform generator 105a, by half the AL which is a pulse width, that is, by approximately 3.5 μsec. An ejection waveform signal generated by the third waveform generator 105c is phase-delayed from the ejection waveform signal generated by the second waveform generator 105b, by half the AL. An ejection waveform signal generated by the fourth waveform generator 105d is phase-delayed from the ejection waveform signal generated by the third waveform generator 105c, by half the AL. In FIG. 7, upper two graphs shows a case where the number of ejected ink droplets is three. The third graph from the top shows a case where the number of ejected ink droplets is two. The lowermost graph shows a case where the number of ejected ink droplets is one. Any of the waveform generators 105a to 105d can generate ejection waveform signals for one to three ink droplet(s).

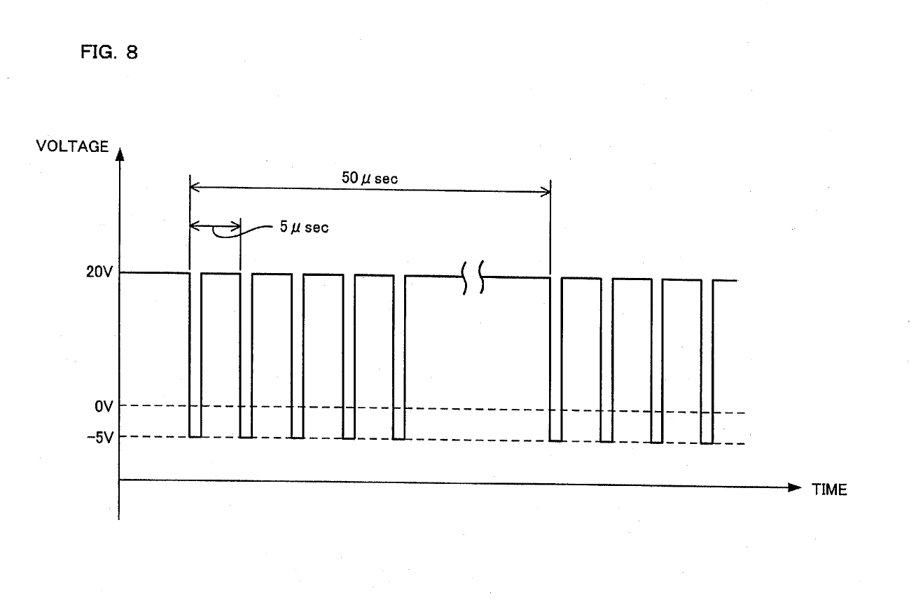

The preliminary vibration waveform generator 106 generates a first preliminary vibration waveform signal and a second preliminary vibration waveform signal, which function as a preliminary vibration waveform signal for vibrating and stirring ink in the nozzle 8 without ejecting the ink from the nozzle 8. FIG. 8 shows a fundamental waveform of the preliminary vibration waveform signal that is generated by the preliminary vibration waveform generator 106. As shown in FIG. 8, like the ejection waveform signal, the preliminary vibration waveform signal is a group of rectangular concave waves, and determined by a phase and a cycle of a waveform pattern. The fundamental waveform includes, in one printing cycle, five slight vibration pulses that produce slight vibration. The printing cycle means a time period required for a paper to be conveyed by a unit distance that corresponds to a printing resolution. Each of the slight vibration pulses has a width of 1 μsec, which is smaller than a width of the AL. Five slight vibration pulses come in succession at intervals of 4 μsec. At 20 kHz for example, one printing cycle is 50 μsec. For up to 25 μsec from the beginning of the printing cycle, five slight vibration pulses come in succession. The remaining 25 μsec is an idle state, in which a potential is kept at the positive potential. The first preliminary vibration waveform signal is a sequence of 50 fundamental waveforms shown in FIG. 8. Thus, the first preliminary vibration waveform signal produces slight vibration 250 times, and the vibration continues for 2.5 msec. The second preliminary vibration waveform signal is a sequence of 30 fundamental waveforms shown in FIG. 8. Thus, the second preliminary vibration waveform signal produces slight vibration 150 times, and the vibration continues for 1.5 msec. A piezoelectric-type actuator inevitably results in a transition period from when voltage is applied to when deformation of the actuator is completed. In this embodiment, the transition period is longer than 1 μsec. Since a width of the slight vibration pulse included in the preliminary vibration waveform signal is 1 μsec, an electrode polarity changes before an amount of deformation of the actuator becomes as large as to cause ink ejection. Therefore, ink in a nozzle 8 is merely vibrated instead of being ejected from the nozzle 8.

In each printing cycle, based on image data, the print signal supplier 107 allocates any of the ejection waveform signals shown in FIG. 7 to each actuator, except for no ejection. Moreover, the print signal supplier 107 allocates the first preliminary vibration waveform signal or the second preliminary vibration waveform signal to an actuator that satisfies a predetermined condition. For every actuator, the print signal supplier 107 determines whether to allocate the preliminary vibration waveform signal or not. The print signal supplier 107 generates a serial print signal based on allocation, and supplies the print signal to a driver IC 80 that corresponds to each actuator unit 21.

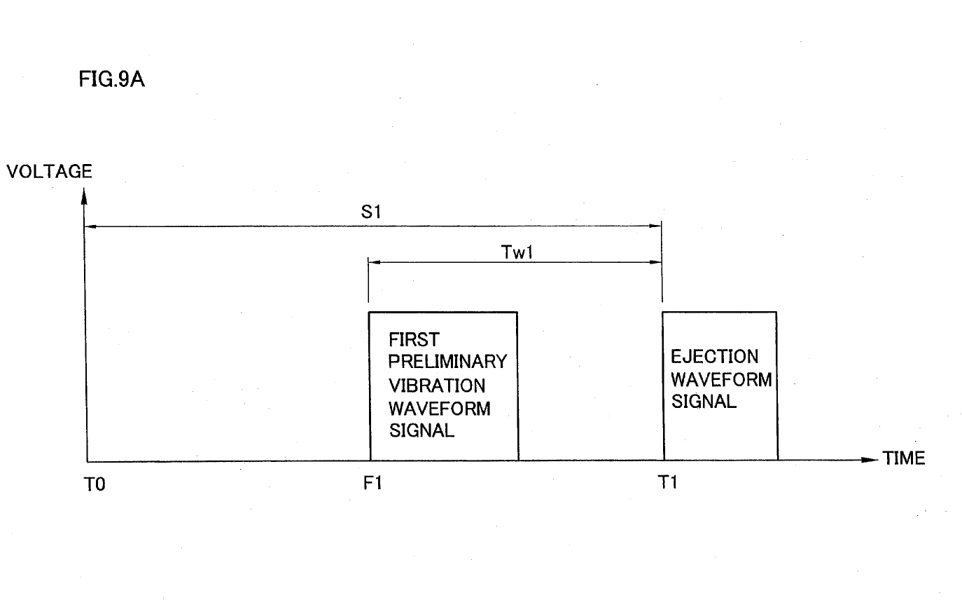

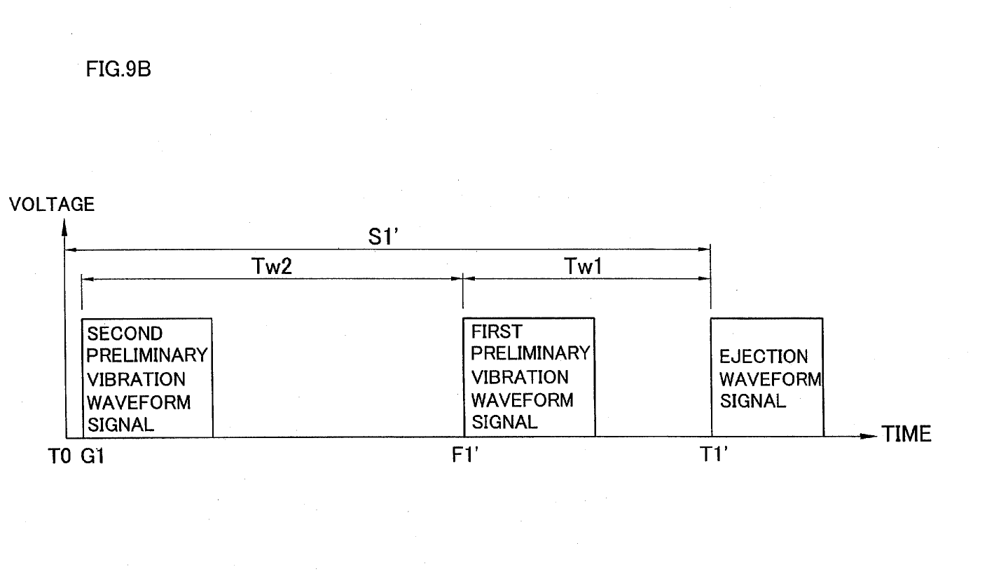

As shown in FIG. 9A, when a time period S1 from a printing start point T0 to a first ejection waveform signal supply point T1 is longer than a predetermined time period Tw1 and shorter than the predetermined time period Tw1 plus a predetermined time period Tw2, the print signal supplier 107 allocates the first preliminary vibration waveform signal at a point F1 which is the predetermined time period Tw1 before the point T1. As shown in FIG. 9B, when a time period S1′ from a printing start point T0 to a first ejection waveform signal supply point T1′ is longer than the predetermined time period Tw1 plus the predetermined time period Tw2, the print signal supplier 107 allocates the first preliminary vibration waveform signal at a point F1′ which is the predetermined time period Tw before the point T1′, and besides allocates the second preliminary vibration waveform signal at a point G1 which is the predetermined time period Tw2 before the point F1′. The time period S1′ from the printing start point T0 to the first ejection waveform signal supply point T1′ becomes longer than the predetermined time period Tw1 plus the predetermined time period Tw2, in a case where an interval between the printing start point T0, at which a paper P starts to be opposed to the most upstream ink-jet head 2, and the first ejection waveform signal supply point is relatively long, e.g., in a case where printing is made only on the vicinity of rear end of the paper P. For the purpose of explanatory convenience, points T1, T1′, time periods S1, S1′, points F1, F1′, and a point G1 for one actuator are shown in FIGS. 9A and 9B. However, they are the same for the other actuators. That is, when the number of actuators which means the number of nozzles 8 is n, the number of points Ti, the number of time periods Si, the number of points Fi, and the number of points Gi are respectively n in total (i=1 to n). Allocation of the preliminary vibration waveform signal occurs only within the time periods S1 and S1′. In the other time periods, the ejection waveform signal alone is allocated.

The predetermined time period Tw1 is preferably 5 msec to 25 msec. In a case where the predetermined time period Tw1 is less than 5 msec, pressure generated in a pressure chamber 10 by a preliminary vibration waveform signal may remain and affect ink ejection which will be made by a next ejection waveform signal. In a case where the predetermined time period Tw1 is more than 25 msec, even though ink in a nozzle 8 is vibrated and stirred, the ink may thicken again and affect ink ejection which will be made by a next ejection waveform signal. The predetermined time period Tw2 is set at such a period that, in a case where there is a relatively large interval between the printing start point T0 and the point T1 and therefore the first preliminary vibration waveform signal alone cannot sufficiently remove thickening of ink in a nozzle 8, a previously-given second preliminary vibration waveform signal allows thickening of ink in the nozzle 8 to be removed by the first preliminary vibration waveform signal. Depending on ink properties, and a temperature and a humidity of the atmosphere, vibration produced by the second preliminary vibration waveform signal can occur several times. In such a case, the predetermined time period Tw2 is set at a period shorter than the above-described one.

The print signal supplier 107 supplies the out-of-phase ejection waveform signals generated by the first to fourth waveform generators 105a to 105d, to individual electrodes 35 that correspond to sixteen nozzle rows 18a to 18d existing within a range of one actuator unit 21. More specifically, the print signal supplier 107 supplies the ejection waveform signal generated by the first waveform generator 105a to individual electrodes 35 corresponding to the first nozzle rows 18a. The print signal supplier 107 supplies the ejection waveform signal generated by the second waveform generator 105b to individual electrodes 35 corresponding to the second nozzle rows 18b. The print signal supplier 107 supplies the ejection waveform signal generated by the third waveform generator 105c to individual electrodes 35 corresponding to the third nozzle rows 18c. The print signal supplier 107 supplies the ejection waveform signal generated by the fourth waveform generator 105d to individual electrodes 35 corresponding to the fourth nozzle rows 18d.

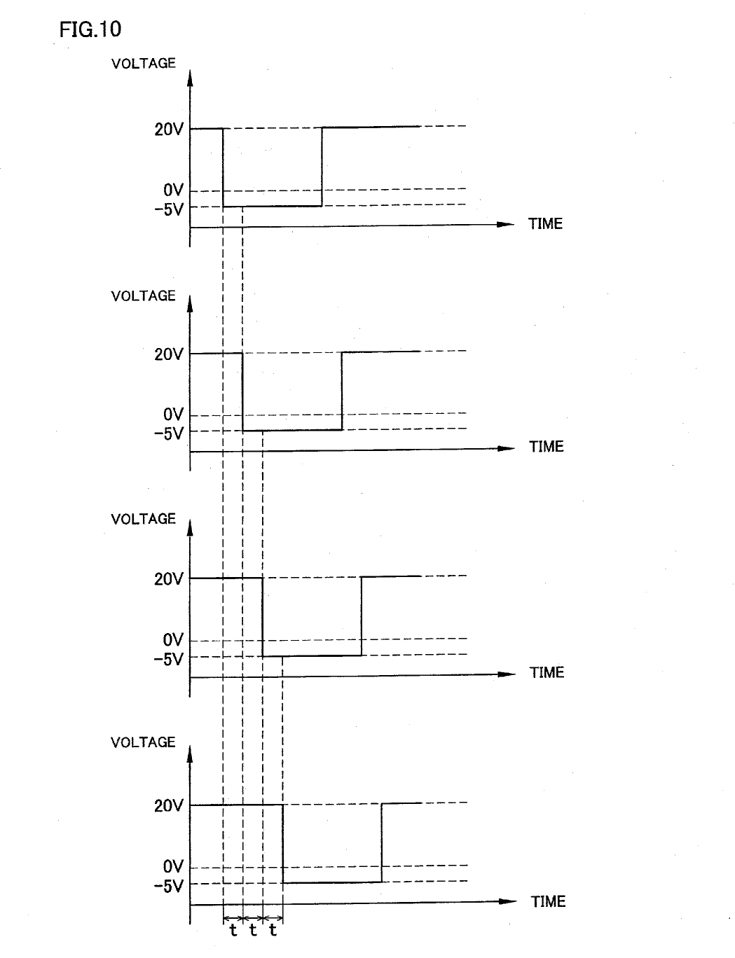

Further, the print signal supplier 107 delays the ejection waveform signals generated by the first to fourth waveform generators 105a to 105d, with a delay time being different for every one of four sub manifold channels 5a existing within the range of one actuator unit 21. Such a delay-amount relationship is indicated by four graphs shown in FIG. 10. That is, when an ejection waveform signal that is supplied to individual electrodes 35 corresponding to, among four sub manifold channels 5a opposed to one actuator unit 21, a first sub manifold channel 5a acting is defined as a reference ejection waveform signal (as indicated by the uppermost graph in FIG. 10), an ejection waveform signal that is supplied to individual electrodes 35 corresponding to a second sub manifold channel 5a neighboring the first sub manifold channel 5a is delayed from the reference ejection waveform signal by a time t, which is 1.25 μsec for example (as indicated by the second uppermost graph in FIG. 10). Ejection waveform signals that are supplied to individual electrodes 35 corresponding to the third and fourth sub manifold channels 5a are delayed from the reference ejection waveform signal by times 2t and 3t, respectively (as indicated by the third and fourth graphs from the top in FIG. 10).

As a result, the print signal supplier 107 outputs ejection waveform signals that are out of phase with each other by sixteen different timings. The number of different timings is the same as the number of nozzle rows existing within the region of one actuator unit 21. That is, the print signal supplier 107 supplies ejection waveform signals of the same phase to, among many individual electrodes 35 existing within the range of one actuator unit 21, individual electrodes 35 corresponding to the same nozzle rows, while supplying ejection waveform signals of different phases to individual electrodes 35 corresponding to the different nozzle rows. Because of the difference in waveform and delay time among the ejection waveform signals, a time point at which a nozzle actually starts ejecting ink differs for every nozzle row. In consideration of this, the predetermined time periods Tw1 and Tw2 described above may take different values for every nozzle row.

The driver IC 80 includes an unillustrated shift register, an unillustrated multiplexer, and an unillustrated drive buffer. The shift register converts a serial print signal outputted from the print signal supplier 107 into a parallel signal, and outputs an individual signal to each individual electrode 35. Based on each signal outputted from the shift register, the multiplexer selects appropriate one among several kinds of ejection waveform signals for ink ejection and two kinds of preliminary vibration waveform signals for preliminary ink vibration. Then, the multiplexer outputs a selected signal to the drive buffer. Based on data outputted from the multiplexer, the drive buffer generates an ejection pulse signal and a vibration pulse signal of predetermined levels, respectively. Then, the multiplexer supplies the signal through the FPC to an individual electrode 35 corresponding to each actuator. The ejection pulse signal is generated based on the ejection waveform signal, and the vibration pulse signal is generated based on the preliminary vibration waveform signal. The actuator unit 21 is thereby driven. More specifically, based on the ejection pulse signal, a desired image is formed on a paper P. Based on the vibration pulse signal, ink in a nozzle 8 is vibrated to such a degree that the ink is not ejected. Before an ejection pulse signal for first ink ejection is supplied to an individual electrode 35, the vibration pulse signal is supplied to the individual electrode 35. Thus, in all the nozzles 8, ink is vibrated and thickening is removed before it is ejected.

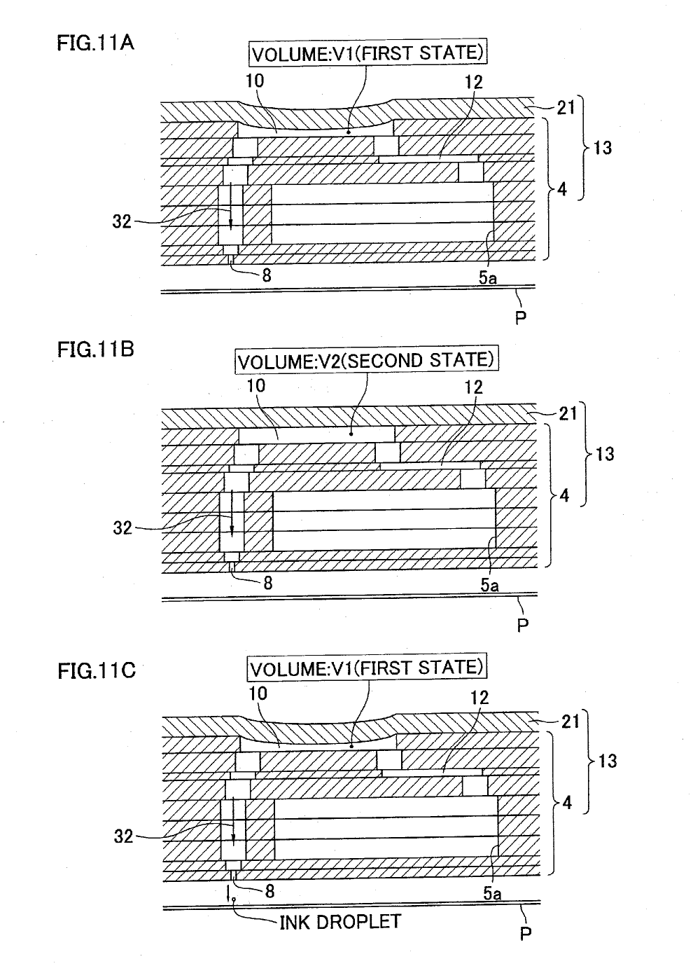

Next, with reference to FIGS. 11A to 11C, a specific description will be given to driving of an actuator that has received the ejection pulse signal. FIGS. 11A to 11C are timewise views showing an ink droplet being ejected from a nozzle 8 by driving of the actuator unit 21.

FIG. 11A shows a state where an individual electrode 35 is at the positive potential. An actuator, which means a region corresponding to the pressure generator J shown in FIG. 4, is under tension and deforms protrudingly toward a pressure chamber 10. At this time, the pressure chamber 10 has a volume V1. This state will be referred to as a first state of the actuator.

FIG. 11B shows a state where the individual electrode 35 is at the negative potential. Stress on the actuator is released, and the actuator is substantially relaxed. At this time, the pressure chamber 10 has a volume V2, which is larger than the volume V1 of the pressure chamber 10 shown in FIG. 11A. This state will be referred to as a second state of the actuator. Since like this the volume of the pressure chamber 10 is increased, ink is sucked from a sub manifold channel 5a into the pressure chamber 10.

FIG. 11C shows a state where the individual electrode 35 is again at the positive potential. Like in FIG. 11A, the actuator deforms protrudingly toward the pressure chamber 10. At this time, the actuator is in the first state. Due to a change from the second state shown in FIG. 11B to the first state shown in FIG. 11C, pressure application to ink in the pressure chamber 10 is caused, so that an ink droplet is ejected from the nozzle 8. The ink droplet lands on an upper face of a paper P, and forms a dot.

An actuator that has received a vibration pulse signal is deforming in such a manner that the volume of the pressure chamber changes from V1 to V2 and then to V1 as shown in FIGS. 11A to 11C. However, deformation of the actuator is not as large as to make ink ejected from the nozzle 8. This is because a width of a rectangular wave of the preliminary vibration waveform signal, which means an interval from a falling to a rising, is set so as not to eject ink from a nozzle 8. Ink in the nozzle 8 is vibrated and stirred by a pressure wave caused by deformation of the actuator.

As thus far described above, in this embodiment, ink in the nozzle 8 is vibrated and stirred when a vibration pulse signal is supplied to the actuator. The vibration pulse signal is supplied to the actuator, while the paper P is being opposed to the ink ejection face 13a, that is, within the time period Si (i=1 to n) (see FIGS. 9A and 9B). An ejection pulse signal is supplied within a relatively short period after the vibration pulse signal is supplied to the actuator. Accordingly, ink ejection from the nozzle 8 can be performed under a condition that thickening of ink in the nozzle 8 has been removed. As a result, ink ejection can be stabilized.

A vibration pulse signal based on a first preliminary vibration waveform signal is supplied to each actuator at the point Fi (i=1 to n) which is the predetermined time period Tw1 before the point Ti (i=1 to n) at which an ejection pulse signal for first ink ejection is supplied (see FIGS. 9A and 9B). Accordingly, there is less difference among nozzles 8, in degree of removal of ink thickening in a nozzle 8. Therefore, ink ejection can be stabilized all the more. In addition, in a case where timings of ink ejection from several nozzles 8 are different from each other, timings of supplying vibration pulse signals to actuators corresponding to the respective nozzles 8 are also different from each other. This can prevent a peak power consumption from becoming too high, and therefore a low power supply can be used.

A vibration pulse signal based on a second preliminary vibration waveform signal is supplied to each actuator at the point Gi (i=1 to n) which is the predetermined time period Tw2 before the point Fi (i=1 to n). Accordingly, ink thickening in a nozzle 8 can more effectively be removed.

The number of rectangular waves included in the second preliminary vibration waveform signal is smaller than the number of rectangular waves included in the first preliminary vibration waveform signal. That is, a change of the volume of the pressure chamber 10 from the first state through the second state to the first state again caused by the vibration pulse signal based on the second preliminary vibration waveform signal is repeated a less number of times than a change of the volume of the pressure chamber 10 from the first state through the second state to the first state again caused by the vibration pulse signal based on the first preliminary vibration waveform signal is repeated. Accordingly, the second preliminary vibration waveform signal consumes smaller power than the first preliminary vibration waveform signal does. Therefore, progress of ink thickening in the nozzle 8 can be suppressed while saving power, and thus total power consumption is also suppressed.

Since the printing start point T0 is determined based on a detection signal from the paper sensor 133, the printing start point T0 can be more stable. Consequently, a timing of ink vibration in a nozzle 8 and a timing of ink ejection from a nozzle 8 are improved in accuracy, so that ink ejection is more stabilized.

In this embodiment, a phase of an ejection pulse signal supplied to an actuator differs for every sub manifold channel 5a, and more specifically for every nozzle row. That is, a timing of driving an actuator differs among the respective nozzle rows. This can prevent a peak power consumption from becoming too high, and therefore a low power supply can be adopted. In addition, this can suppress fluid crosstalk and structural crosstalk involved in a change in volume of the pressure chamber 10. Besides, this allows easy controlling, because actuators corresponding to one nozzle row are supplied with ejection pulse signals of the same phase.

Moreover, a phase of the ejection waveform signal supplied to the actuator differs among the first to fourth nozzle rows 18a to 18d communicating with one sub manifold channel 5a. Therefore, ink in the one sub manifold channel 5a is not simultaneously sucked into individual ink passages 32 corresponding to two or more nozzle rows. This can suppress fluid crosstalk and structural crosstalk. Besides, the first and second preliminary vibration waveform signals given to an actuator also differ in phase among the nozzle rows 18a to 18d. This also can prevent a peak power consumption from becoming too high, and therefore a low power supply can be adopted.

The actuator included in the actuator unit 21 is formed by the piezoelectric sheets 41 to 44 (see FIG. 4). Therefore, control can be made highly accurately. In addition, since the actuator is of piezoelectric type, its power consumption is low and besides little heat is generated. Accordingly, driving the actuator involves no increase in ink thickening.

In the above-described embodiment, the positive potential is 20 V and the negative potential is −5 V (see FIG. 7). However, this is not limitative. As long as the actuator unit 21 can cause a predetermined amount of deformation, the positive and negative potentials can be set at various values based on a construction and a controlling method of the actuator unit 21. For example, it may be possible to set the positive potential at 20 V and a potential corresponding to the negative potential at the ground potential (0V).

A timing of supplying the vibration pulse signal is not limited to the point Fi (i=1, 2, . . . n), but it may be any point within a period from the printing start point T0 to the first ejection pulse signal supply point Ti (i=1, 2, . . . n).

It suffices that the number of rectangular waves included in the first preliminary vibration waveform signal is 500 or less and the number of rectangular waves included in the second preliminary vibration waveform signal is 500 or less.

The rectangular wave included in the first and second preliminary vibration waveform signals may have any width, as long as ink is not ejected from the nozzle 8 but instead ink in the nozzle 8 is vibrated.

The paper sensor 133 may not necessarily be provided Another detector instead of the paper sensor 133 may be provided.

A phase of the ejection pulse signal may not differ among the nozzle rows 18a to 18d communicating with one sub manifold channel 5a. Therefore, the first to fourth waveform generators 105a to 105d may be formed as one waveform generator. Thus, a construction of the controller 100 is simplified. In such a case as well, load on a power supply, fluid crosstalk, and structural crosstalk can be reduced by making a difference in phase of the ejection pulse signal among the sub manifold channels 5a. To the contrary, it may be possible to make no difference in phase of the ejection pulse signal among the sub manifold channels 5a but to make a difference in phase of the ejection pulse signal among the nozzle rows 18a to 18d. In such a case as well, load on a power supply, fluid crosstalk, and structural crosstalk can be reduced.

In the above-described embodiment, the paper P having a rectangular shape is adopted as a recording medium However, a rolled paper may also be employed. In this case, the paper feed unit 114 is replaced with one adapted for a rolled paper. For example, in order to perform first ink ejection at a portion of a rolled paper spaced from a leading edge thereof by a distance equivalent to 2 to 3 papers P coming in sequence along their longitudinal direction, a vibration pulse signal is supplied within a period from the printing start point T0, at which the leading edge of the rolled paper starts to be opposed to an ink ejection face, to the first ejection pulse signal supply point. Thus, the same effects as in the above-described embodiment can be obtained even when a rolled paper having an elongated length is adopted as a recording medium.

Although in the above-described embodiment ink is ejected by means of “fill before fire”, ink may be ejected by means of “fill after fire”, too. For this case, an individual electrode 35 is in advance set at a negative potential or the ground potential, and upon every ejection request it is set at a positive potential. At a timing of setting the individual electrode 35 at the positive potential, a portion of the piezoelectric sheets 41 to 44 corresponding to an active portion protrudingly deforms toward a pressure chamber 10. This reduces the volume of the pressure chamber 10 thus raising pressure of ink contained in the pressure chamber 10, so that ink is ejected from a nozzle 8.

The above-described ink-jet printer 1 is a line printer having the fixed heads 2, but the present invention is applicable to a serial printer having a reciprocating head, too.

Applications of the present invention are not limited to printers. It is also applicable to facsimiles, copying machines, and the like.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. An ink-jet recording apparatus comprising:
an ink-jet head that performs printing while moving relative to a recording medium, and includes an ink ejection face having a plurality of nozzles formed thereon, a plurality of pressure chambers each communicating with each of the nozzles, and a plurality of actuators adapted to take two states, that is, a first state where the actuator sets a volume of the pressure chamber at V1 and a second state where the actuator sets a volume of the pressure chamber at V2 which is larger than V1; and
an actuator controller that supplies to the actuator an ejection pulse signal that appropriately switches the actuator between the two states to thereby make ink ejected from the nozzle, and a vibration pulse signal that appropriately switches the actuator between the two states to thereby, instead of making ink ejected from the nozzle, vibrates ink in the nozzle,
wherein, when a time period Si (i=1, 2, . . . n), which is from a printing start point T0 at which at least a part of a recording medium starts to be opposed to the ink ejection face with respect to a direction of ink ejection from the nozzle to a point Ti (i=1, 2, . . . n) at which the ejection pulse signal is firstly supplied to actuators each corresponding to each of n nozzles (n denotes an arbitrary natural number) that are intended to eject ink based on print data, is longer than a predetermined time period Tw1, the actuator controller supplies the vibration pulse signal to each of the actuators within the time period Si.

2. The ink-jet recording apparatus according to claim 1, wherein the actuator controller supplies the vibration pulse signal to each of the actuators at a point Fi (i=1, 2, . . . n) which is the predetermined time period Tw1 before the point Ti (i=1, 2, . . . n).

3. The ink-jet recording apparatus according to claim 2, wherein, when the time period Si is longer than the predetermined time period Tw1 plus a predetermined time period Tw2, the actuator controller supplies the vibration pulse signal to each of the actuators at a point Gi (i=1, 2, . . . n) which is the predetermined time period Tw2 before the point Fi.

4. The ink-jet recording apparatus according to claim 3, wherein a change of state from the first state through the second state to the first state again caused at the point Gi by the vibration pulse signal is repeated a less number of times than the change of state caused at the point Fi by the vibration pulse signal is.

5. The ink-jet recording apparatus according to claim 1, further comprising a detector that detects a recording medium immediately before the recording medium is brought into opposition to the ink ejection face,
wherein the printing start point T0 is determined based on detection of a recording medium by the detector.

6. The ink-jet recording apparatus according to claim 1, wherein:
the plurality of nozzles are classified into a plurality of nozzle groups; and
the actuator controller supplies ejection pulse signals whose phases are the same for each nozzle group to the actuators corresponding to the respective nozzle groups, while supplying ejection pulse signals whose phases are different for each nozzle group to the actuators corresponding to different nozzle groups.

7. The ink-jet recording apparatus according to claim 6, wherein:
the ink-jet head further includes a plurality of common ink chambers that communicate with each other;
the plurality of nozzles included in each nozzle group communicate with one of the common ink chambers; and
the actuator controller supplies, to the actuators, ejection pulse signals whose phases are different between actuators corresponding to the plurality of nozzles communicating through the pressure chambers with one common ink chamber and actuators corresponding to the plurality of nozzles communicating through the pressure chambers with another common ink chamber.

8. The ink-jet recording apparatus according to claim 7, wherein:
each common ink chamber communicates through the pressure chambers to the plurality of nozzles included in two or more nozzle groups; and
the actuator controller supplies ejection pulse signals of the same phase to, among the actuators corresponding to each common ink chamber, actuators corresponding to the same nozzle group, while supplying to actuators corresponding to different nozzle groups ejection pulse signals whose phases are different for each nozzle group.

9. The ink-jet recording apparatus according to claim 7, wherein a width of a rectangular wave included in the ejection pulse signal is equal to Acoustic Length (AL) that is a time length required for a pressure wave to propagate through ink from an outlet of the common ink chamber via the pressure chamber to the nozzle.

10. The ink-jet recording apparatus according to claim 1, wherein the time period Tw1 is 5 msec to 25 msec.

11. The ink-jet recording apparatus according to claim 1, wherein the actuator includes:
a first electrode that is held at a constant potential;
a second electrode that is disposed at a position opposed to the pressure chamber, and supplied with the ejection pulse signal and the vibration pulse signal from the actuator controller; and
a piezoelectric member that is sandwiched between the first electrode and the second electrode.

12. The ink-jet recording apparatus according to claim 1, wherein the ejection pulse signal brings the actuator from the first state through the second state to the first state again to thereby make ink ejected from the nozzle, and the vibration pulse signal brings the actuator from the first state through the second state to the first state again to thereby, instead of making ink ejected from the nozzle, vibrate ink in the nozzle.
